(19) United States
(12) Patent Application Publication
(10) Pub. No.: US 2017/0355156 A1
(43) Pub. Date: Dec. 14, 2017

(54) Method for Repairing Vinyl Window Frames

(71) Applicants: Dale Swanson, Lakewood, CO (US); Ramona Swanson, Lakewood, CO (US)

(72) Inventors: Dale Swanson, Lakewood, CO (US); Ramona Swanson, Lakewood, CO (US)

(21) Appl. No.: 15/619,809

(22) Filed: Jun. 12, 2017

Related U.S. Application Data
(60) Provisional application No. 62/348,191, filed on Jun. 10, 2016.

(51) Int. Cl. B29C 73/04; B29C 73/26; B29K 27/06

(52) U.S. Cl. CPC B29C 73/04; B29C 73/26; B29K 2027/06; B29C 2073/264

(57) ABSTRACT

A method for recovering vinyl window frames. The method of recovering vinyl window frames includes identifying damages in an existing vinyl frame having a plurality of planes, wherein the damages exist in at least one plane, measuring the area of the frame to be covered, creating a template of the frame by securing pre-cut plates together with a gap between to allow for bending along the gap, such that the template can conform to the frame, marking cuts to be made to the replacement cover using the template, cutting the replacement cover to duplicate the existing frame, and applying the replacement cover over the existing vinyl frame.

### CROSS REFERENCE TO RELATED APPLICATIONS

This application claims the benefit of U.S. Provisional Application No. 62/348,191 filed on Jun. 10, 2016. The above identified patent application is herein incorporated by reference in its entirety to provide continuity of disclosure.

### BACKGROUND OF THE INVENTION

The present invention relates to a method for repairing vinyl. More specifically, the present invention provides a method for recovering a vinyl window frame.

Many window frames are composed of a vinyl material, which can be substantially damaged. Such damage, if not properly addressed, can lead to further problems, such as allowing leaks to pass therethrough, or the accumulation of insects within the vinyl frame itself. One option to deal with the damage is to replace the entire window frame, however such an action could be unnecessary, leading to unwarranted expenses. Therefore, a method of repairing vinyl window frames that doesn't require a complete replacement of the window frame is provided.

In light of the devices disclosed in the known art, it is submitted that the present invention substantially diverges in design elements from the known art and consequently it is clear that there is a need in the art for an improvement to existing vinyl repair methods. In this regard, the instant invention substantially fulfills these needs.

### SUMMARY OF THE INVENTION

In view of the foregoing disadvantages inherent in the known methods of repairing vinyl frames now present in the prior art, the present invention provides a method of repairing vinyl frames wherein the same can be utilized for providing convenience for the user when repairing vinyl window frames.

The present system comprises a method for recovering vinyl window frames comprising identifying damages in an existing vinyl frame having a plurality of planes, wherein the damages exist in at least one plane. The area of the existing vinyl frame to be covered is then measured. A template is created by securing pre-cut plates together such that a gap is formed sufficient to allow the pre-cut plates to bend about the gaps to conform to each plane of the existing vinyl frame. The template is then used to guide the user in marking the cuts to be made in the replacement cover. The replacement cover is then cut to duplicate the existing vinyl frame, and then applied over the existing vinyl frame.

In some embodiments, the edges of the replacement cover are sanded to provide a blended appearance with the existing vinyl frame. In yet other embodiments, weep holes are cut into the replacement cover. In some embodiments, the replacement cover is painted to match the color of the existing vinyl frame. In yet other embodiments, the replacement cover is sealed by applying silicone along the edges of the replacement cover. In some embodiments, grooves are cut in the replacement cover to provide flexibility. In yet other embodiments, the replacement cover is bent along those grooves to conform to the shape of the existing vinyl frame. In some embodiments, the replacement cover is secured to the existing vinyl frame by at least one adhesive. In yet other embodiments, the adhesives used include silicone and cyanoacrylate. In some embodiments, the area to be covered is measured by applying tape to the area and cutting the applied tape to the shape and size of the area to be covered. In yet other embodiments, the tape is then removed and used as a guide for the cuts to be made to the replacement cover.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the template being used to approximate the shape of the existing vinyl frame.

FIG. 2 shows a perspective view of an embodiment of the template being used to mark cuts to be made into the replacement cover.

FIG. 3 shows a perspective view of an embodiment of the vinyl frame being measured with tape.

FIG. 4A shows a perspective view of an embodiment of the replacement cover with a groove.

FIG. 4B shows a perspective view of an embodiment of the replacement cover being bent along the groove.

FIG. 5 shows a perspective view of an embodiment of the replacement cover being applied to the existing vinyl frame.

### DETAILED DESCRIPTION OF THE INVENTION

Reference is made herein to the attached drawings. Like reference numerals are used throughout the drawings to depict like or similar elements of the method of repairing vinyl frames. The figures are intended for representative purposes only and should not be considered to be limiting in any respect.

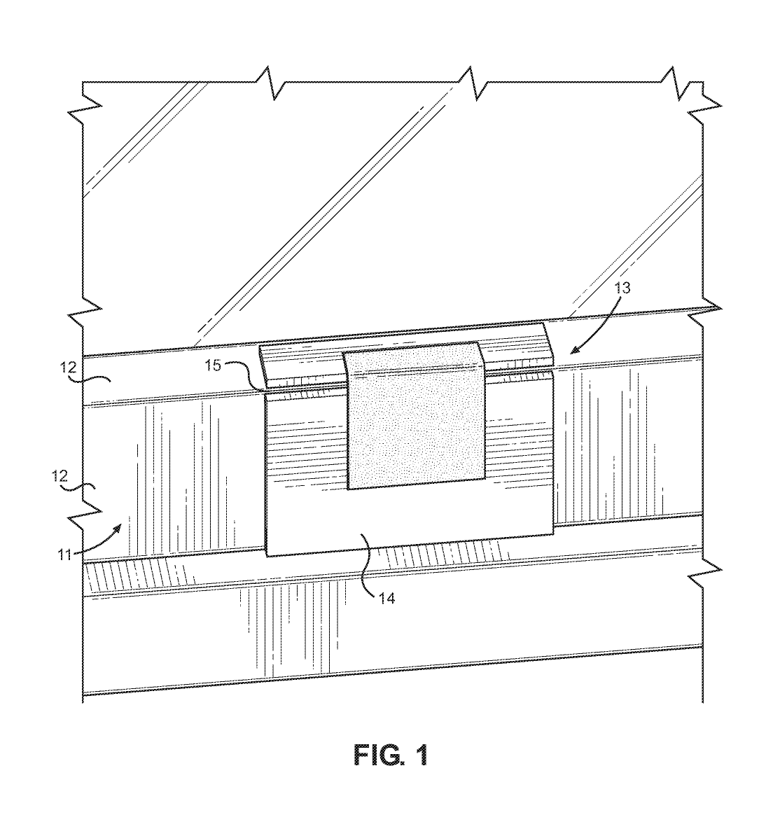

Referring now to FIG. 1, there is shown a perspective view of an embodiment of the template being used to approximate the shape of the existing vinyl frame. An existing vinyl frame 11 comprises a plurality of planes 12. In the present invention, a template 13 is used to form the shape of an existing vinyl frame 11 that has been damaged, such that the damaged portion of the vinyl frame can be recovered without having to replace the entire window frame. The template 13 comprises a combination of pre-cut plates 14 secured together such that a gap 15 is formed. In the illustrated embodiment, the pre-cut plates 14 are secured together via an adhesive strip. The template 13 is adapted to bend about the gap 15 such that the template 13 can conform to the shape of the existing vinyl frame 11. The gap 15 extends the entire length of the pre-cut plates 14. The width of the gap 15 is at least as large as the thickness of the pre-cut plates 14. In this way, the template 13 is free to bend about the gap 15 without the pre-cut plates 14 interfering with the movement thereof. Each of the pre-cut plates 14 are adapted to rest flush against each of the plurality of planes 12.

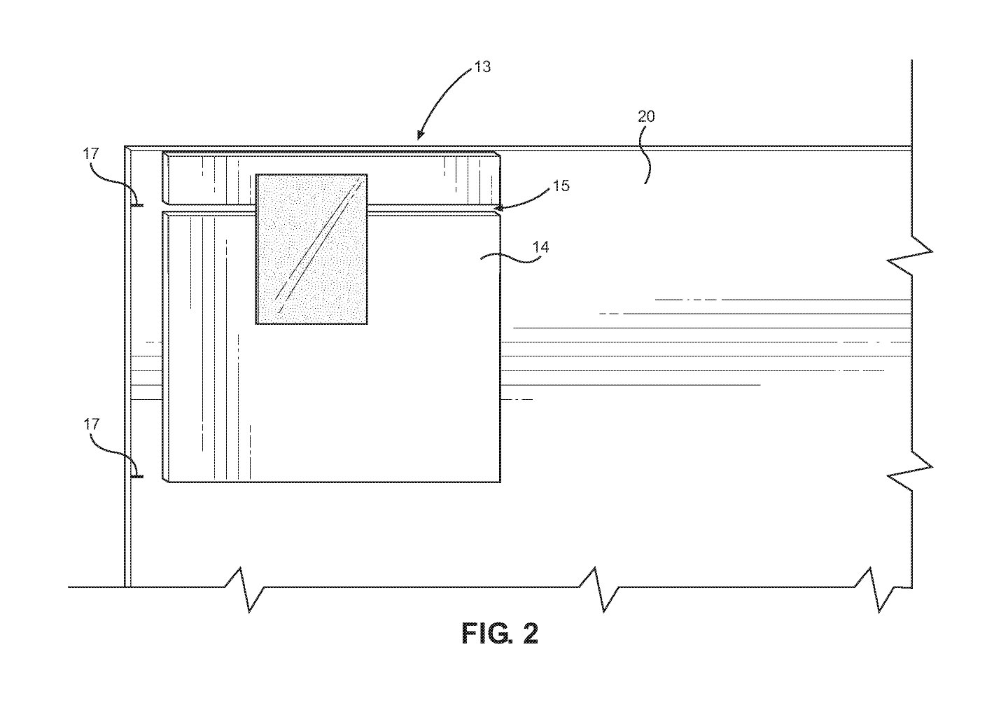

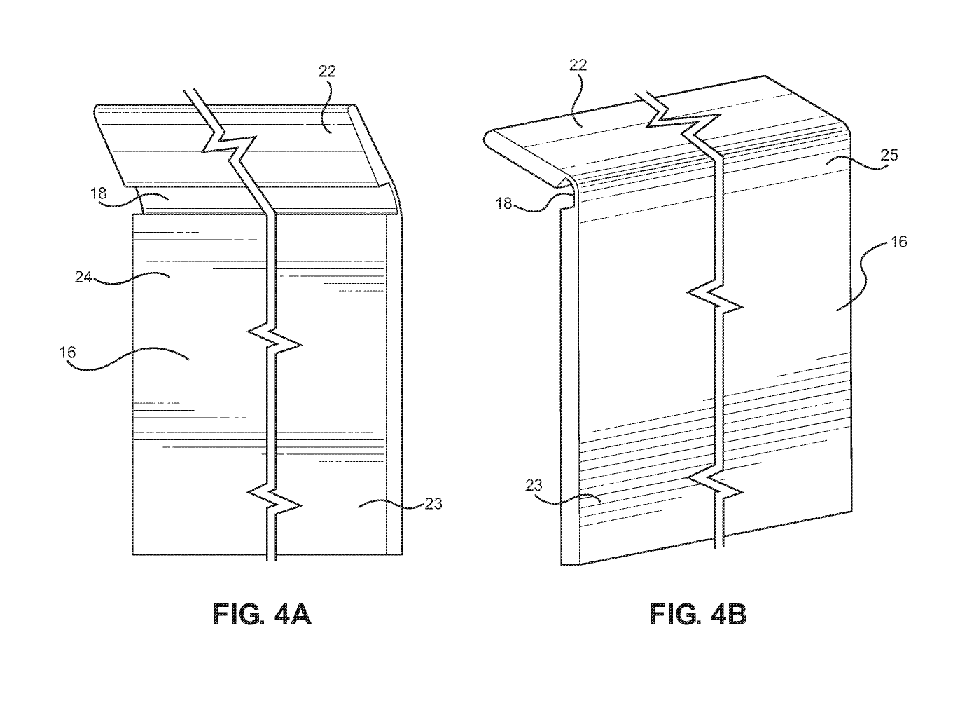

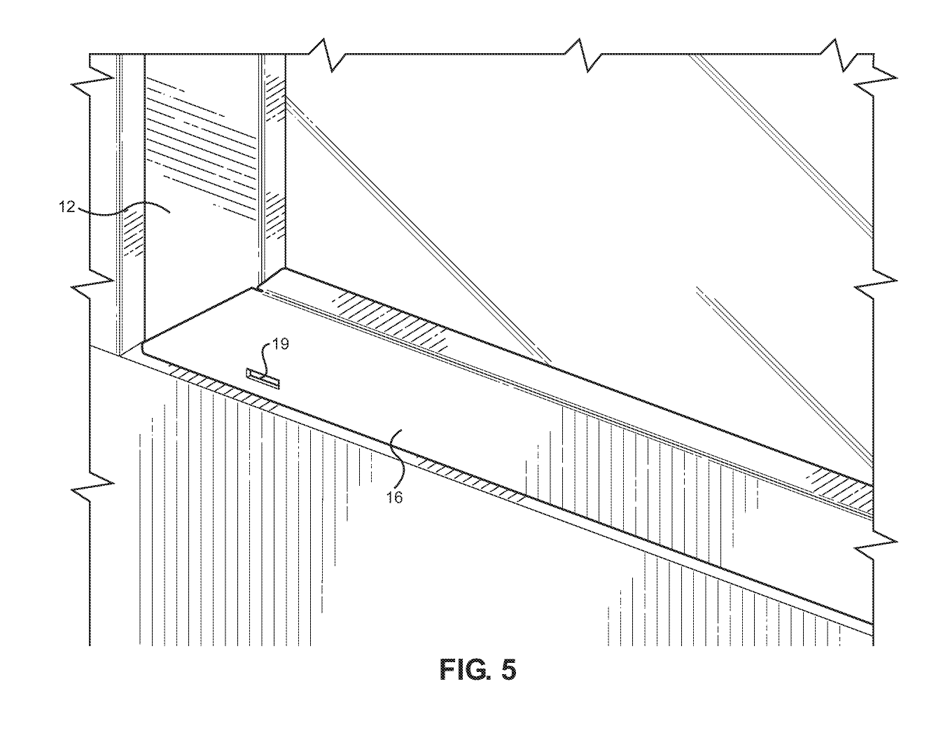

Referring now to FIG. 2, there is shown a perspective view of an embodiment of the template being used to mark cuts to be made into the replacement cover. The template 13 is placed on a vinyl sheet 20 to determine where cuts should be made to create a replacement cover (shown in FIG. 4, 16). Cut markings 17 are made on the vinyl sheet 20 following along the base of each of the pre-cut plates 14. In this way, the gap 15 and the base of the template 13 are marked to designate where the vinyl sheet 20 should be cut to duplicate the section of the existing vinyl frame 11 to be covered. In other embodiments, a weep hole (shown in FIG. 5, 19) is cut into the vinyl sheet 20.

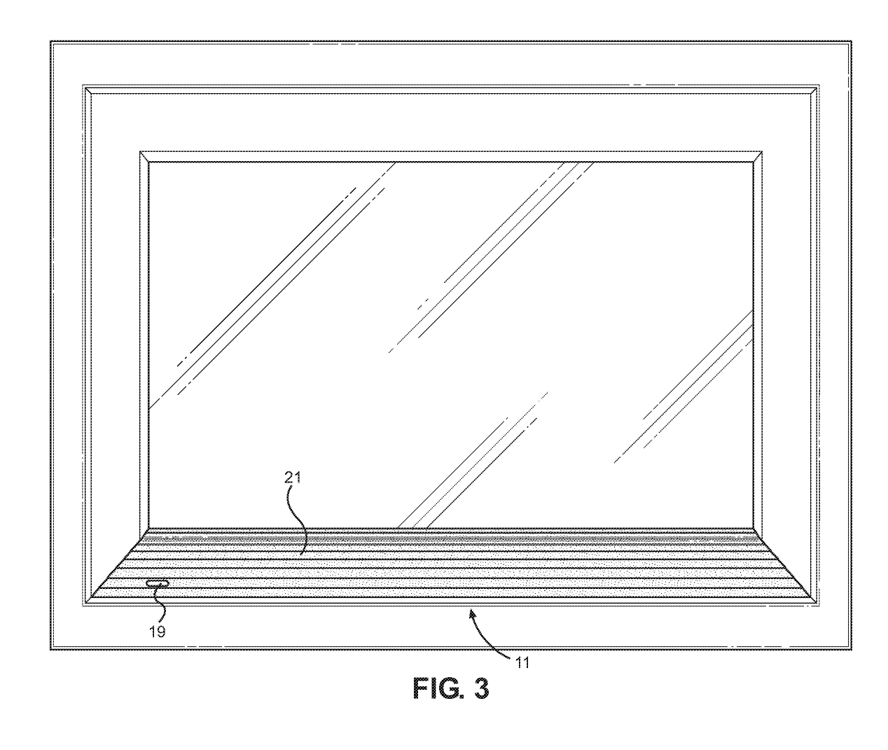

Referring now to FIG. 3, there is shown a perspective view of an embodiment of the vinyl frame being measured using tape. In the illustrated embodiment, tape 21 is applied to the portion of the existing vinyl frame 11 that the user wishes to recover to measure the area to be covered. In some embodiments, after the tape 21 is cut to the same size and shape of the existing vinyl frame 11 to be covered, the tape 21 is removed and used to outline further cuts to be made in the vinyl sheet. In the illustrated embodiment, the tape 21 comprises a series of individual strips layered on top of each other creating a single sheet of connected tape 21. If a weep hole 19 is present in the existing vinyl frame 11, the tape 21 can be cut to indicate the location of the weep hole 19 to be marked when cutting the vinyl sheet.

Referring now to FIGS. 4A and 4B, there is shown a perspective view of an embodiment of the replacement cover with a groove and a perspective view of an embodiment of the replacement cover being bent along the groove, respectively. The vinyl sheet is cut along the cut markings such that it can conform to the shape of the existing vinyl frame and rest flush against each of the plurality of planes. In some embodiments, a groove 18 is created in the replacement cover 16 along the marking designated by the gap in the template. The groove 18 is cut by making a shallow cut along the length of the vinyl sheet and extends along the length of the replacement cover 16. The groove 18 allows the replacement cover 16 to be bent about the groove 18 such that the replacement cover 16 can rest flush against the plurality of planes. In the illustrated embodiment, the replacement cover 16 comprises an upper section 22 and a lower section 23, wherein the upper and lower sections 22, 23 are disposed on opposing sides of the groove 18. The replacement cover 16 further comprises a front side 24 having the groove 18 disposed thereon, and a rear side 25, wherein the rear side 25 comprises a planar surface. In this way, the rear side 25 represents the visible surface when the replacement cover 16 is applied to the existing vinyl frame. In some embodiments, the replacement cover 16 comprises multiple grooves 18, such that the replacement cover 16 can rest flush against an existing vinyl frame having at least three planes.

Referring now to FIG. 5, there is shown a perspective view of an embodiment of the replacement cover being applied to the existing vinyl frame. The replacement cover 16 is applied to the plurality of planes 12. In some embodiments, the replacement cover 16 is secured to the plurality of planes 12 by at least one adhesive. In some embodiments, the replacement cover 16 is secured to the plurality of planes 12 by silicone and cyanoacrylate, such that the cyanoacrylate provides a fast adherence, and the silicone provides a long term securing solution that expands and contracts in response to changes in the temperature of the environment. In another embodiment, an adhesive film is applied over the replacement cover 16 after it is installed. The adhesive film provides protection to paint applied and serves to reinforce the replacement cover 16 about the groove. In yet other embodiments, the edges of the replacement cover 16 are sanded to be thinner and appear to blend with the plurality of planes 12. In some embodiments, the replacement cover 16 is painted to match the color of the existing vinyl frame. In yet other embodiments, silicone is applied along the edges of the replacement cover 16 to seal it against the environment.

Referring to FIGS. 1-5, in one use, the user examines the existing vinyl frame 11 for damage. Upon finding damage in at least one plane of the plurality of planes 12, the user measures the area of the existing vinyl frame 11 that must be covered to remedy the damage. In one embodiment, the measurement process includes taping the section of the existing vinyl frame 11 to be covered. This tape is cut to take on the shape of the section to be covered. The user then removes the tape to use as a guide when cutting the replacement cover 16 to duplicate the section of the existing vinyl frame 11 to be covered. A template 13 is created using a selection of pre-cut plates 14. The pre-cut plates 14 are adapted to approximate the shape and size of each of the plurality of planes 12. The pre-cut plates 14 are taped together such that a gap 15 is formed between them. The gap 15 allows the template 13 to bend such that the pre-cut plates 14 rest flush with each of the plurality of planes 12. The template 13 is then placed on the vinyl sheet 20, and cut markings 17 are made on the vinyl sheet 20 indicating where cuts must be made to create the replacement cover 16. The vinyl sheet 20 is then cut along the cut markings 17 to create the replacement cover 16. In some embodiments, the cuts made along the cut markings 17 made within the gap 15 of the template 13 create a groove 18. The groove 18 in the replacement cover 16 allows the replacement cover 16 to be bent along the groove 18 to conform to the shape of the existing vinyl frame 11. The replacement cover 16 is then applied to the existing vinyl frame 11. In some embodiments, the replacement cover 16 is secured by at least one adhesive, such as silicone and cyanoacrylate. In some embodiments, the replacement cover 16 is then painted to match the color of the existing vinyl frame 11. In yet other embodiments, the edges of the replacement cover 16 are sanded to blend the replacement cover 16 with the existing vinyl frame. In some embodiments, silicone is applied along the edges of the replacement cover 16 in order to provide a seal against the elements.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method for recovering vinyl window frames, comprising:
identifying damages in an existing vinyl frame having a plurality of planes, wherein the damages exist in at least one plane;
measuring the area of the existing vinyl frame to be covered;
creating a template of the existing vinyl frame by securing pre-cut plates together such that a gap sufficient to allow the pre-cut plates to bend about the gaps to conform to each plane of the existing vinyl frame is formed between each plate;
marking cuts to be made in a replacement cover following the gaps in the template;
cutting the replacement cover to duplicate the existing vinyl frame; and
applying the replacement cover over the existing vinyl frame.

2) The method for recovering vinyl window frames of claim 1, further comprising sanding the edges of the replacement cover to blend the cover with the existing vinyl frame.

3) The method for recovering vinyl window frames of claim 1, further comprising cutting at least one weep hole in the replacement cover, wherein the weep hole is configured to drain liquid accumulated within the existing vinyl frame.

4) The method for recovering vinyl window frames of claim 1, further comprising painting the replacement cover to match the color of the existing vinyl frame.

5) The method for recovering vinyl window frames of claim 1, further comprising applying silicone along the edges of the replacement cover to provide a seal.

6) The method for recovering vinyl window frames of claim 1, wherein cutting the replacement cover includes cutting grooves in the replacement cover to provide flexibility.

7) The method for recovering vinyl window frames of claim 6, further comprising bending the replacement cover along the grooves to conform to the shape of the existing vinyl frame.

8) The method for recovering vinyl window frames of claim 1, wherein applying the replacement cover includes securing the replacement cover to the existing vinyl frame with at least one adhesive.

9) The method for recovering vinyl window frames of claim 8, wherein the at least one adhesive used comprise silicone and cyanoacrylate.

10) The method for recovering vinyl window frames of claim 1, wherein measuring the area of the existing vinyl frame to be covered includes applying tape to the area of the existing vinyl frame to be covered and cutting the applied tape to the shape and size of the area of the existing vinyl frame to be covered.

11) The method for recovering vinyl window frames of claim 10, wherein cutting the replacement cover includes removing the applied tape from the existing vinyl frame using the removed tape as a guide for the cuts.
